(19) United States
(12) Patent Application Publication
(10) Pub. No.: US 2024/0251313 A1
(43) Pub. Date: Jul. 25, 2024

(54) SYSTEMS AND METHODS FOR FAST SWITCHING FROM A PRIVATE NETWORK TO A PUBLIC NETWORK FOR EMERGENCY SERVICES

(71) Applicant: Verizon Patent and Licensing Inc., Basking Ridge, NJ (US)

(72) Inventors: Hongkun LI, Basking Ridge, NJ (US); Deepa JAGANNATHA, Bridgewater, NJ (US); Chintankumar PATEL, Edison, NJ (US)

(73) Assignee: Verizon Patent and Licensing Inc., Basking Ridge, NJ (US)

(21) Appl. No.: 18/159,510

(22) Filed: Jan. 25, 2023

(51) Int. Cl. H04W 36/14; H04W 4/90; H04W 48/16

(52) U.S. Cl. CPC H04W 36/14; H04W 4/90; H04W 48/16

(57) ABSTRACT

A network device may receive network data identifying core networks supported by the network device and emergency service data identifying one or more of the core networks that support emergency services. The network device may generate, based on the network data and the emergency service data, system information that includes identifiers of the core networks and indicators of whether the core networks support emergency services. The network device may provide the system information to a user equipment to inform the user equipment about which of the core networks support emergency services.

### BACKGROUND

In a multi-operator core network arrangement, a radio access network (RAN) device (e.g., an eNode B, a gNodeB, and/or the like) is shared among multiple independent network operators. Each of the network operators may deploy a core network, which could be a public core network (e.g., a public land mobile network (PLMN)), a private or non-public core network, or the combination of a public core network and a private core network.

### BRIEF DESCRIPTION OF THE DRAWINGS

FIGS. 1A-1E are diagrams of an example associated with fast switching from a private network to a public network for emergency services.

FIG. 2 is a diagram of an example environment in which systems and/or methods described herein may be implemented.

FIG. 3 is a diagram of example components of one or more devices of FIG. 2.

FIG. 4 is a flowchart of an example process for fast switching from a private network to a public network for emergency services.

### DETAILED DESCRIPTION OF EXAMPLE EMBODIMENTS

The following detailed description of example implementations refers to the accompanying drawings. The same reference numbers in different drawings may identify the same or similar elements.

In a multi-operator core network arrangement, the shared RAN device broadcasts a system information block (SIB) (e.g., an SIB1) that includes a list of core networks that are available from the shared RAN device. The SIB may include an Internet protocol multimedia subsystem (IMS) emergency support bit that indicates whether the RAN device supports IMS emergency bearer services for a user equipment (UE) via a fifth-generator core network/evolved packet core (EPC) network. The SIB may include identifiers of the core networks (e.g., PLMN IDs), a cell identifier (ID) for the cell generated by the RAN device, a tracking area code (TAC) for the RAN device, a RAN area code, and/or the like. In a multi-operator core network arrangement that includes a RAN device shared by 5G standalone (SA) core network and an independent private core network, voice-over-New-Radio (VoNR) emergency services may not be supported.

When VoNR emergency services are not supported and a UE attempts an emergency call, the UE will search for an available network supporting emergency services in order to complete the emergency call. The UE may perform an emergency attach/registration procedure on any available voice supported public core network. When VoNR emergency services are not supported in 5G SA, the UE is expected to perform emergency registration to a public 5G SA network or an emergency evolved packet system (EPS) fallback procedure for emergency services. The EPS fallback procedure causes the UE to move from a 5G core network to an EPC (e.g., via handover or redirection) for emergency voice call completion. The UE may complete the emergency call on the EPC using a voice-over-Long-Term-Evolution (VoLTE) procedure. However, in a multi-operator core network arrangement that includes a RAN device shared by a 5G SA core network and a private core network, the UE may select a core network that does not support emergency services even though the RAN device may indicate that emergency services are supported by the RAN device. This is due to the fact that the IMS emergency support bit is based on the cell provided by the RAN device. With multiple core networks from different network operators sharing the RAN device, the UE is unable to determine which core network supports emergency services. Therefore, the UE may select a core network that does not support the emergency services even if the RAN device indicates the support for emergency services.

Thus, current network and UE configurations consume computing resources (e.g., processing resources, memory resources, communication resources, and/or the like), networking resources, and/or other resources associated with failing to provide emergency services for a UE that selects a core network that does not support emergency services, the UE repeatedly attempting to attach to a core network that supports emergency services, unnecessarily utilizing, for an emergency call, the RAN device and a core network that fails to support emergency services, and/or the like.

Some implementations described herein provide a network device (e.g., a RAN device) that provides fast switching from a private network to a public network for emergency services. For example, the RAN device may receive network data identifying core networks supported by the RAN device and emergency data identifying one or more of the core networks that support emergency services. The RAN device may generate, based on the network data and the emergency data, an SIB that includes identifiers of the core networks and indicators of whether the core networks support emergency services, and may provide the SIB to a UE to inform the UE about which of the core networks support emergency services. The RAN device may receive, from the UE, an emergency call directed to one of the core networks that supports emergency services, as selected by the UE based on the identifiers and the indicators included in the SIB. The RAN device may direct the emergency call request to the one of the core networks that supports emergency services. Alternatively, or additionally, the RAN device may receive service data identifying service types provided by the core networks and may generate, based on the network data and the service data, a list identifying the core networks and priorities associated with service types provided by the core networks. The RAN device may provide the list to the UE to inform the UE about the priorities associated with the service types provided by the core networks. The RAN device may receive, from the UE, a request for a service type, directed to one of the core networks that supports the service type, as selected by the UE based on the list, and may direct the request for the service type to the one of the core networks that supports the service type.

In this way, the RAN device provides fast switching from a private network to a public network for emergency services. For example, the RAN device may generate an SIB with an IMS emergency support bit that indicates whether each of the core networks supported by the RAN device provides emergency services. In other words, in the system information broadcast by a shared RAN device, there is an IMS emergency support bit for each core network that shares the RAN device. This may enable the UE to determine whether each of the core networks shared with the RAN device supports emergency services. Therefore, the UE may select a core network that supports emergency services and may establish an emergency call more quickly via the selected core network. The RAN device may also assign priorities to service types provided by the core networks supported by the RAN device. For example, a first core network may be assigned a higher priority for emergency services, a second core network may be assigned a higher priority for augmented reality and/or virtual reality (AR/VR) video and/or voice services, and/or the like. The RAN device may provide the service type priorities to the UE, and the UE may select a core network for a desired service based on the service type priorities assigned to the core networks. Thus, the RAN device may conserve computing resources, networking resources, and/or other resources that would have otherwise been consumed by failing to provide emergency services for a UE that selects a core network that does not support emergency services, the UE repeatedly attempting to attach to core networks that fail to support emergency services, unnecessarily utilizing, for an emergency call, the RAN device and a core network that fails to support emergency services, and/or the like.

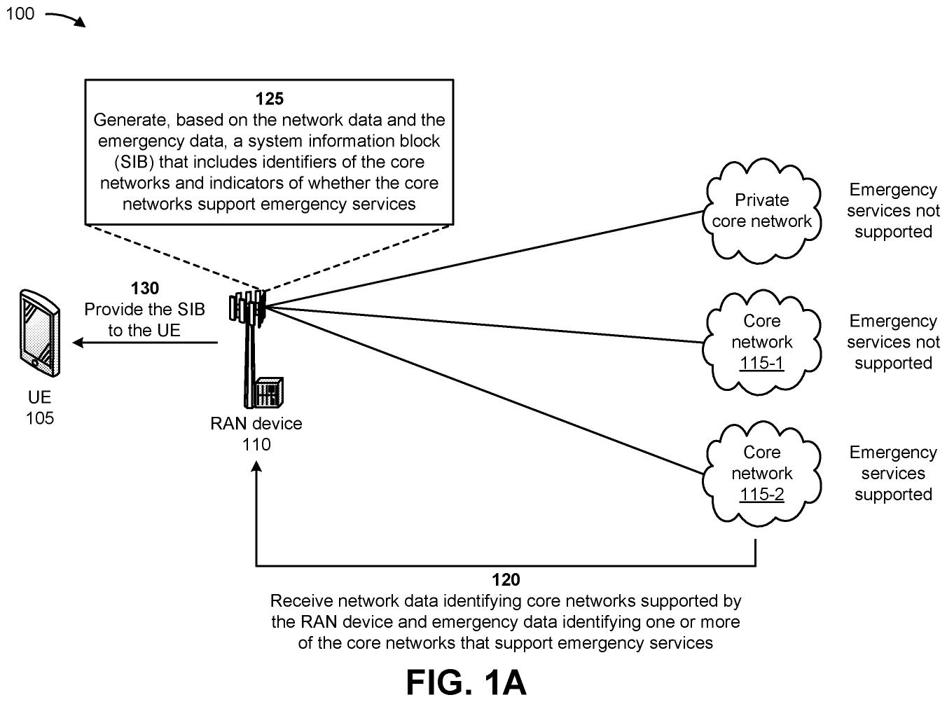

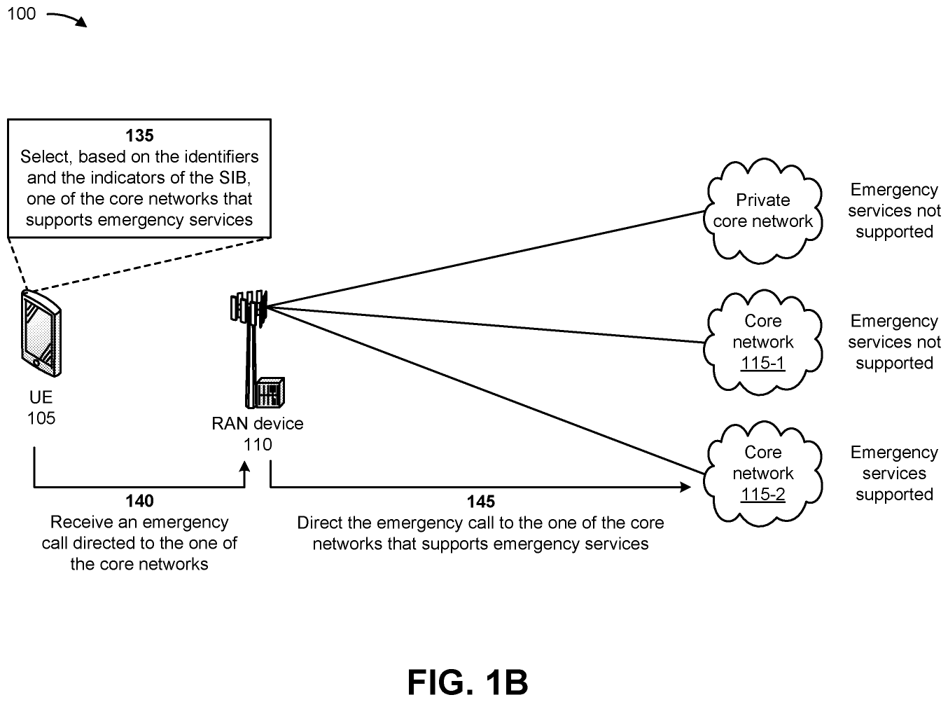

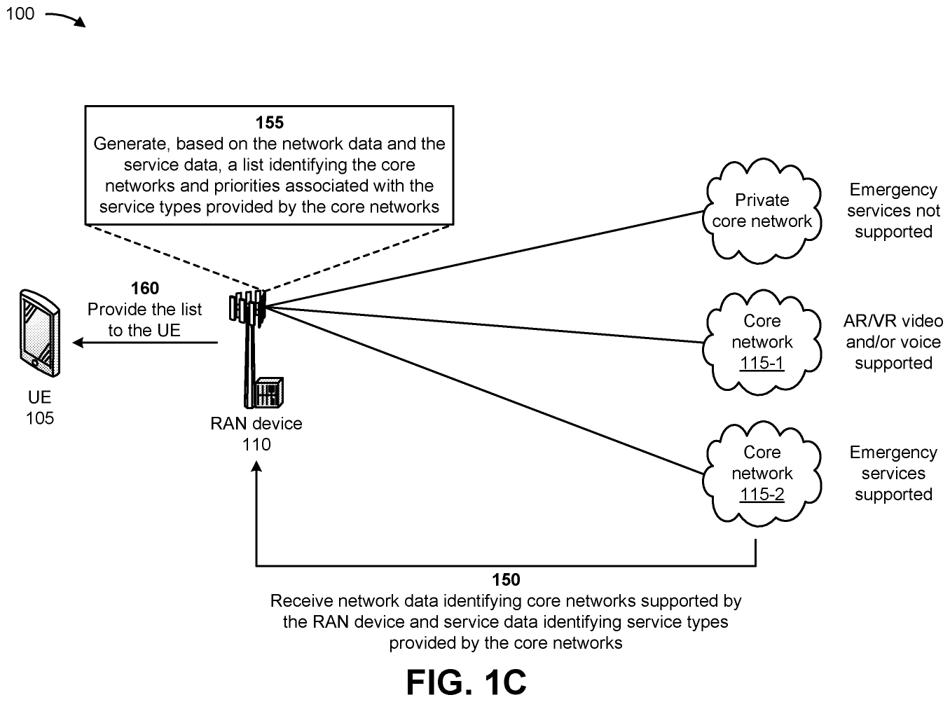

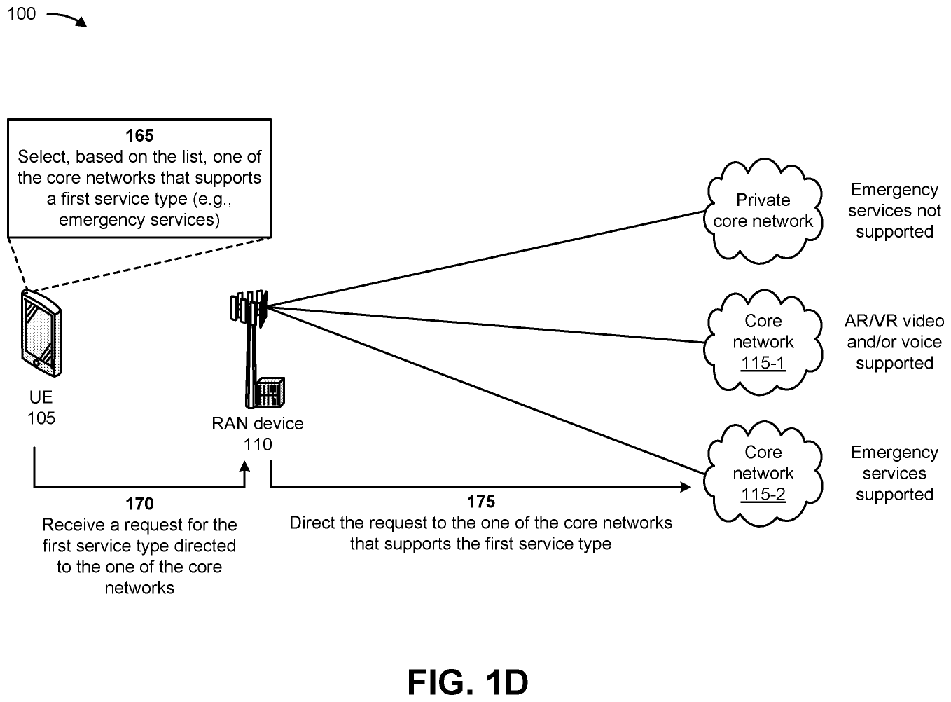

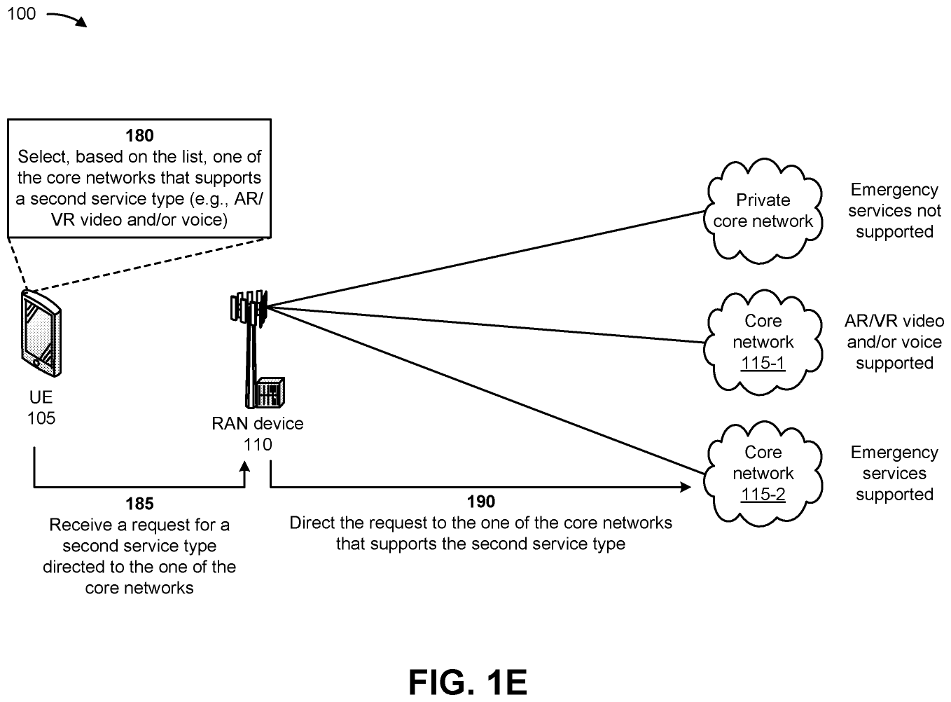

FIGS. 1A-1E are diagrams of an example 100 associated with fast switching from a private network to a public network for emergency services. As shown in FIGS. 1A-1E, example 100 includes a UE 105, a RAN device 110, a private core network, and core networks 115 (e.g., a first core network 115-1 and a second core network 115-2). The private core network may include a computer network that uses a private address space of Internet protocol (IP) addresses. The addresses may be utilized for local area networks in residential, office, and/or enterprise environments. In some implementations, the private core network and the first core network 115-1 may not support emergency services, and the second core network 115-2 may support emergency services. Further details of the UE 105, the RAN device 110, the private core network, and the core networks 115 are provided elsewhere herein.

As shown in FIG. 1A, and by reference number 120, the RAN device 110 may receive network data identifying core networks supported by the RAN device 110 and emergency data identifying one or more of the core networks that support emergency services. For example, the RAN device 110 may support the private core network, the first core network 115-1, and the second core network 115-2. The private core network and the first core network 115-1 may be associated with a first network operator and the second core network 115-2 may be associated with a second network operator that is different than the first network operator. The private core network, the first core network 115-1, and the second core network 115-2 may generate network data identifying the private core network, the first core network 115-1, and the second core network 115-2. The network data may include an identifier of the private core network, an identifier (e.g., a PLMN ID) of the first core network 115-1, an identifier (e.g., a PLMN ID) of the second core network 115-2; data identifying infrastructure of the private core network, the first core network 115-1, and the second core network 115-2; and/or the like. The private core network, the first core network 115-1, and the second core network 115-2 may provide the network data to the RAN device 110, and the RAN device 110 may receive the network data from the private core network, the first core network 115-1, and the second core network 115-2.

In some implementations, the private core network, the first core network 115-1, and the second core network 115-2 may provide different service types that may be utilized by the UE 105. For example, the private core network and the first core network 115-1 may not support emergency services, but the second core network 115-2 may support emergency services. The private core network, the first core network 115-1, and the second core network 115-2 may generate the emergency data identifying one or more of the core networks that support emergency services. For example, the emergency data may indicate that the private core network and the first core network 115-1 fail to support emergency services, but that the second core network 115-2 supports emergency services. The private core network, the first core network 115-1, and the second core network 115-2 may provide the emergency data to the RAN device 110, and the RAN device 110 may receive the emergency data from the private core network, the first core network 115-1, and the second core network 115-2.

As further shown in FIG. 1A, and by reference number 125, the RAN device 110 may generate, based on the network data and the emergency data, an SIB that includes identifiers of the core networks and indicators of whether the core networks support emergency services. For example, the RAN device 110 may utilize the network data to determine the identifiers of the core networks, such as an identifier of the private core network, an identifier (e.g., a PLMN ID) of the first core network 115-1, an identifier (e.g., a PLMN ID) of the second core network 115-2, and/or the like. The RAN device 110 may utilize the emergency data to identify the core networks that support emergency services, such as the second core network 115-2. The RAN device 110 may generate indicators indicating whether the core networks support emergency services. For example, the RAN device 110 may generate a first indicator indicating that the private core network does not support emergency services, a second indicator indicating that the first core network 115-1 does not support emergency services, a third indicator indicating that the second core network 115-2 supports emergency services, and/or the like.

The RAN device 110 may generate a data element (e.g., an SIB) that includes the identifiers of the core networks and the indicators of whether the core networks support emergency services. In some implementations, the indicators of whether the core networks support emergency services may be included in an IMS emergency support bit of the SIB. In some implementations, the SIB may include other information, such as cell access information associated with the RAN device 110 (e.g., a PLMN ID list, a non-public network (NPN) ID list, and/or the like), cell selection information and criteria, scheduling information associated with other SIBs, UE timers and constants for radio resource control (RRC) management, serving cell parameters, and/or the like.

As further shown in FIG. 1A, and by reference number 130, the RAN device 110 may provide the SIB to the UE 105. For example, the RAN device 110 may provide, to the UE 105, the SIB that includes the identifiers of the core networks and the indicators of whether the core networks support emergency services. The UE 105 may receive the SIB and may store the SIB in memory associated with the UE 105. In some implementations, the SIB (e.g., the IMS emergency support bit of the SIB) may inform the UE 105 about which of the core networks support emergency services. In this way, the UE 105 may be able to select a core network that supports emergency services and set up an emergency service (e.g., an emergency call) more quickly with the selected core network.

As shown in FIG. 1B, and by reference number 135, the UE 105 may select, based on the identifiers and the indicators of the SIB, one of the core networks that supports emergency services. For example, the UE 105 may be connected to the private core network and a user of the UE 105 may cause the UE 105 to generate an emergency call. Based on the emergency call, the UE 105 may review the identifiers and the indicators of the SIB to identify one of the core networks that supports emergency services. For example, based on reviewing the identifiers and the indicators of the SIB, the UE 105 may identify the second core network 115-2 as a core network that supports emergency services. Thus, the UE 105 may select the second core network 115-2 for handling the emergency call, and may provide, with the emergency call, information that directs the emergency call to the second core network 115-2.

As further shown in FIG. 1B, and by reference number 140, the RAN device 110 may receive, from the UE 105, an emergency call directed to the one of the core networks. For example, the UE 105 may provide the emergency call (e.g., with the information that directs the emergency call to the second core network 115-2) to the RAN device 110, and the RAN device 110 may receive the emergency call from the UE 105.

As further shown in FIG. 1B, and by reference number 145, the RAN device 110 may direct the emergency call to the one of the core networks that supports emergency services. For example, the RAN device 110 may analyze the information that directs the emergency call to the one of the core networks (e.g., the second core network 115-2), and may determine that the emergency call is to be directed to the second core network 115-2 based on the information. The RAN device 110 may direct the emergency call to the second core network 115-2 based on the determination. The UE 105 may utilize the second core network 115-2 to complete the emergency call with an emergency service.

As shown in FIG. 1C, and by reference number 150, the RAN device 110 may receive network data identifying core networks supported by the RAN device 110 and service data identifying service types provided by the core networks. For example, the private core network, the first core network 115-1, and the second core network 115-2 may provide the network data to the RAN device 110, and the RAN device 110 may receive the network data from the private core network, the first core network 115-1, and the second core network 115-2, as described above in connection with FIG. 1A.

In some implementations, the private core network, the first core network 115-1, and the second core network 115-2 may provide different service types that may be utilized by the UE 105. For example, the private core network and the first core network 115-1 may not support emergency services, the second core network 115-2 may support emergency services, the first core network 115-1 may support AR/VR voice and/or video services, the second core network 115-2 may support VoNR services, and/or the like. The private core network, the first core network 115-1, and the second core network 115-2 may generate the service data identifying the service types provided by the core networks. For example, the service data may indicate that the private core network and the first core network 115-1 fail to support emergency services, that the second core network 115-2 supports emergency services, that the first core network 115-1 supports AR/VR voice and/or video services, that the second core network 115-2 supports VoNR services, and/or the like. The private core network, the first core network 115-1, and the second core network 115-2 may provide the service data to the RAN device 110, and the RAN device 110 may receive the service data from the private core network, the first core network 115-1, and the second core network 115-2.

As further shown in FIG. 1C, and by reference number 155, the RAN device 110 may generate, based on the network data and the service data, a list identifying the core networks and priorities associated with the service types provided by the core networks. For example, the RAN device 110 may utilize the network data to determine the identifiers of the core networks, such as an identifier of the private core network, an identifier (e.g., a PLMN ID) of the first core network 115-1, an identifier (e.g., a PLMN ID) of the second core network 115-2, and/or the like. The RAN device 110 may utilize the service data to determine the priorities associated with the service types provided by the core networks. For example, the RAN device 110 may determine that the second core network 115-2 is preferred for a first service type (e.g., emergency services) and may assign a highest priority to the second core network 115-2 for the first service type. In another example, the RAN device 110 may determine that the first core network 115-1 is preferred for a second service type (e.g., AR/VR voice and/or video services) and may assign a highest priority to the first core network 115-1 for the second service type. The RAN device 110 may generate a list that includes the identifiers of the core networks and the priorities associated with the service types provided by the core networks. In some implementations, the RAN device 110 may include the list in the SIB to be provided to the UE 105.

As further shown in FIG. 1C, and by reference number 160, the RAN device 110 may provide the list to the UE 105. For example, the RAN device 110 may provide, to the UE 105, the list that includes the identifiers of the core networks and the priorities associated with the service types provided by the core networks. The UE 105 may receive the list and may store the list in memory associated with the UE 105. In some implementations, the list may inform the UE 105 about which priorities are associated with the service types provided by the core networks. In this way, the UE 105 may be able to select a core network that supports a particular service type and may receive the particular service type more quickly from the selected core network.

As shown in FIG. 1D, and by reference number 165, the UE 105 may select, based on the list, one of the core networks that supports a first service type. For example, the UE 105 may be connected to the private core network and a user of the UE 105 may cause the UE 105 to generate a request for a first service type (e.g., an emergency call). Based on the emergency call, the UE 105 may review the priorities associated with the service types provided by the core networks to identify one of the core networks with a highest priority for the first service type. For example, based on reviewing the priorities associated with the service types provided by the core networks, the UE 105 may identify the second core network 115-2 as a core network with a highest priority for emergency services. Thus, the UE 105 may select the second core network 115-2 for handling the emergency call, and may provide, with the emergency call, information that directs the emergency call to the second core network 115-2.

As further shown in FIG. 1D, and by reference number 170, the RAN device 110 may receive a request for the first service type directed to the one of the core networks. For example, the UE 105 may provide the request for the first service type (e.g., the emergency call with the information that directs the emergency call to the second core network 115-2) to the RAN device 110, and the RAN device 110 may receive the request for the first service type from the UE 105.

As further shown in FIG. 1D, and by reference number 175, the RAN device 110 may direct the request to the one of the core networks that supports the first service type. For example, the RAN device 110 may analyze the information that directs the request for the first service type (e.g., the emergency call) to the one of the core networks (e.g., the second core network 115-2), and may determine that the emergency call is to be directed to the second core network 115-2 based on the information. The RAN device 110 may direct the emergency call to the second core network 115-2 based on the determination. The UE 105 may utilize the second core network 115-2 to complete the emergency call with an emergency service.

As shown in FIG. 1E, and by reference number 180, the UE 105 may select, based on the list, one of the core networks that supports a second service type. For example, the UE 105 may be connected to the private core network and a user of the UE 105 may cause the UE 105 to generate a request for a second service type (e.g., AR/VR voice and/or video services). Based on the request for the second service type, the UE 105 may review the priorities associated with the service types provided by the core networks to identify one of the core networks with a highest priority for the second service type. For example, based on reviewing the priorities associated with the service types provided by the core networks, the UE 105 may identify the first core network 115-1 as a core network with a highest priority for AR/VR voice and/or video services. Thus, the UE 105 may select the first core network 115-1 for handling the request for the second service type, and may provide, with the request for the second service type, information that directs the request for the second service type to the first core network 115-1.

As further shown in FIG. 1E, and by reference number 185, the RAN device 110 may receive a request for a second service type directed to the one of the core networks. For example, the UE 105 may provide the request for the second service type (e.g., with the information that directs the request for the second service type to the first core network 115-1) to the RAN device 110, and the RAN device 110 may receive the request for the second service type from the UE 105.

As further shown in FIG. 1E, and by reference number 190, the RAN device 110 may direct the request to the one of the core networks that supports the second service type. For example, the RAN device 110 may analyze the information that directs the request for the second service type to the one of the core networks (e.g., the first core network 115-1), and may determine that the request for the second service type is to be directed to the first core network 115-1 based on the information. The RAN device 110 may direct the request for the second service type to the first core network 115-1 based on the determination. The UE 105 may utilize the first core network 115-1 to receive the second service type.

In some implementations, the techniques described in connection with FIGS. 1A and 1B or the techniques described in connection with FIGS. 1C-1E may be provided by RAN device 110. Alternatively, the techniques described in connection with FIGS. 1A and 1B and the techniques described in connection with FIGS. 1C-1E may be provided by RAN device 110. Although implementations are described in connection with 5G core networks, the implementations may also be utilized in connection with 4G core networks, 6G core networks, and/or the like.

In this way, the RAN device 110 provides fast switching from a private network to a public network for emergency services. For example, the RAN device 110 may generate an SIB with an IMS emergency support bit that indicates whether each of the core networks 115 supported by the RAN device 110 provides emergency services. This may enable the UE 105 to determine whether each of the core networks 115 shared with the RAN device 110 supports emergency services. Therefore, the UE 105 may select a core network 115 that supports emergency services and may establish an emergency call more quickly via the selected core network 115. The RAN device 110 may also assign priorities to service types provided by the core networks 115 supported by the RAN device 110. For example, a first core network 115 may be assigned a highest priority for emergency services, a second core network 115 may be assigned a highest priority for AR/VR video and/or voice services, and/or the like. The RAN device 110 may provide the service type priorities to the UE 105, and the UE 105 may select a core network 115 for a desired service based on the service priorities assigned to the core networks 115. Thus, the RAN device 110 may conserve computing resources, networking resources, and/or other resources that would have otherwise been consumed by failing to provide emergency services for a UE 105 that selects a core network 115 that does not support emergency services, the UE 105 repeatedly attempting to attach to core networks 115 that fail to support emergency services, unnecessarily utilizing, for an emergency call, the RAN device 110 and a core network 115 that fails to support emergency services, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

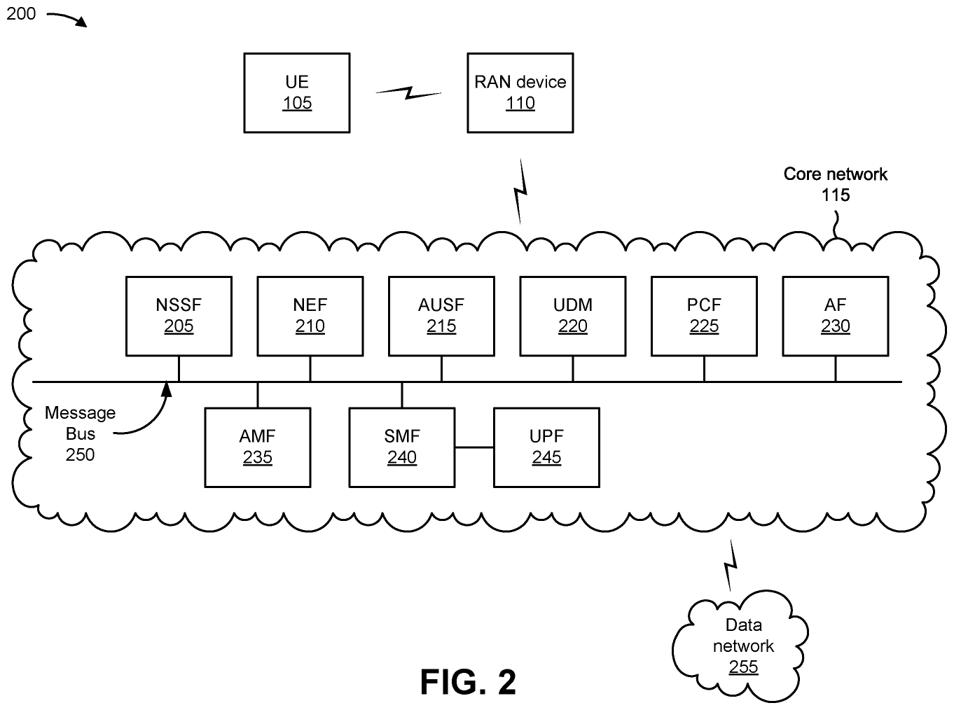

FIG. 2 is a diagram of an example environment 200 in which systems and/or methods described herein may be implemented. As shown in FIG. 2, the example environment 200 may include the UE 105, the RAN device 110, the core network 115, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN device 110 may support, for example, a cellular radio access technology (RAT). The RAN device 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, microcell base stations, microcell base stations, picocell base stations, femtocell base stations, or similar types of devices) and other network entities that can support wireless communication for the UE 105. The RAN device 110 may transfer traffic between the UE 105 (e.g., using a cellular RAT), one or more base stations (e.g., using a wireless interface or a backhaul interface, such as a wired backhaul interface), and/or the core network 115. The RAN device 110 may provide one or more cells that cover geographic areas.

In some implementations, the RAN device 110 may perform scheduling and/or resource management for the UE 105 covered by the RAN device 110 (e.g., the UE 105 covered by a cell provided by the RAN device 110). In some implementations, the RAN device 110 may be controlled or coordinated by a network controller, which may perform load balancing, network-level configuration, and/or other operations. The network controller may communicate with the RAN device 110 via a wireless or wireline backhaul. In some implementations, the RAN device 110 may include a network controller, a self-organizing network (SON) module or component, or a similar module or component. In other words, the RAN device 110 may perform network control, scheduling, and/or network management functions (e.g., for uplink, downlink, and/or sidelink communications of the UE 105 covered by the RAN device 110).

In some implementations, the core network 115 may include an example functional architecture in which systems and/or methods described herein may be implemented. For example, the core network 115 may include an example architecture of a 5G next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce UE IP address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third-party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

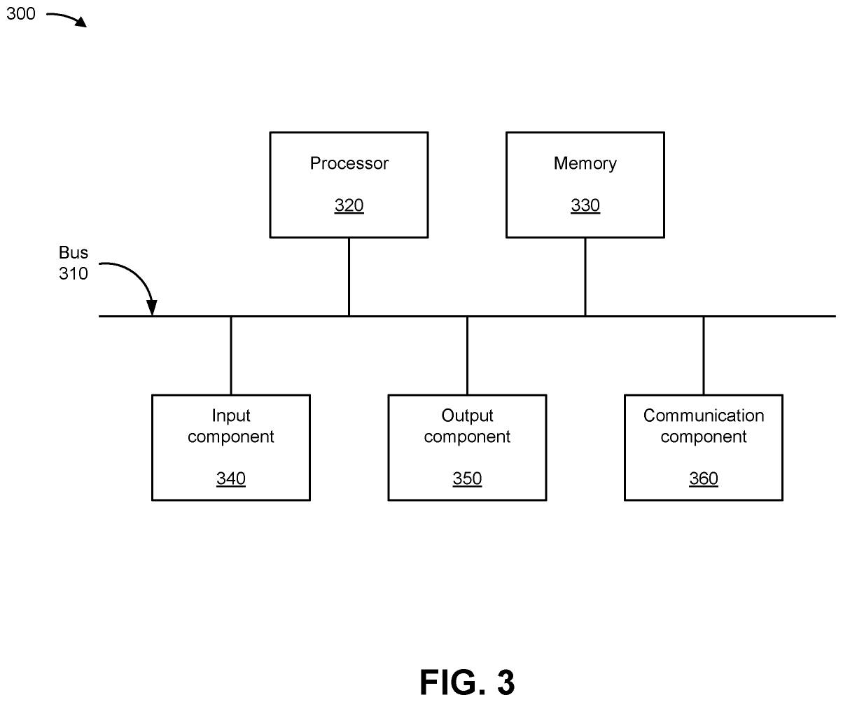

FIG. 3 is a diagram of example components of a device 300, which may correspond to the UE 105, the RAN device 110, the NSSF 205, the NEF 210, the AUSF 215, the UDM 220, the PCF 225, the AF 230, the AMF 235, the SMF 240, and/or the UPF 245. In some implementations, the UE 105, the RAN device 110, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

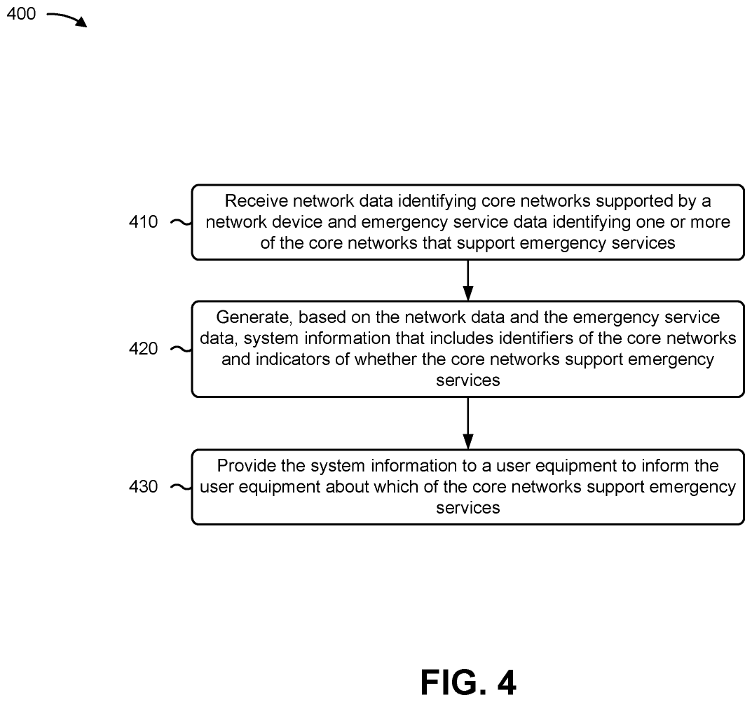

FIG. 4 is a flowchart of an example process 400 for providing fast switching from a private network to a public network for emergency services. In some implementations, one or more process blocks of FIG. 4 may be performed by a network device (e.g., the RAN device 110). In some implementations, one or more process blocks of FIG. 4 may be performed by another device or a group of devices separate from or including the network device, such as a UE (e.g., the UE 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving network data identifying core networks supported by a network device and emergency service data identifying one or more of the core networks that support emergency services (block 410). For example, the network device may receive network data identifying core networks supported by the network device and emergency service data identifying one or more of the core networks that support emergency services, as described above. In some implementations, the core networks are 5G standalone core networks. In some implementations, the core networks are 4G EPC networks. In some implementations, the network device is a RAN device. In some implementations, a quantity of the core networks is greater than or equal to two, and at least one of the core networks supports emergency services.

As further shown in FIG. 4, process 400 may include generating, based on the network data and the emergency service data, system information that includes identifiers of the core networks and indicators of whether the core networks support emergency services (block 420). For example, the network device may generate, based on the network data and the emergency service data, system information that includes identifiers of the core networks and indicators of whether the core networks support emergency services, as described above. In some implementations, an emergency support bit of the system information includes the identifiers of the core networks and the indicators of whether the core networks support emergency services.

As further shown in FIG. 4, process 400 may include providing the system information to a UE to inform the UE about which of the core networks support emergency services (block 430). For example, the network device may provide the system information to a UE to inform the UE about which of the core networks support emergency services, as described above. In some implementations, the UE is connected to a private network supported by the network device.

In some implementations, process 400 includes receiving, from the UE, an emergency call directed to one of the core networks that supports emergency services, as selected by the UE based on the identifiers and the indicators included in the system information, and directing the emergency call to the one of the core networks that supports emergency services.

In some implementations, process 400 includes receiving service data identifying service types provided by the core networks; generating, based on the network data and the service data, a list identifying the core networks and priorities associated with service types provided by the core networks; and providing the list to the UE to inform the UE about the priorities associated with the service types provided by the core networks. In some implementations, process 400 includes receiving, from the UE, a request for a first service type, directed to one of the core networks that supports the first service type, as selected by the UE based on the list, and directing the request for the first service type to the one of the core networks that supports the first service type. In some implementations, the one of the core networks is associated with a greatest priority for the first service type relative to the core networks other than the one of the core networks.

In some implementations, process 400 includes receiving, from the UE, a request for a second service type, directed to another one of the core networks that supports the second service type, as selected by the UE based on the list; and directing the request for the second service type to the other one of the core networks that supports the second service type. In some implementations, the other one of the core networks is associated with a greatest priority for the second service type relative to the core networks other than the other one of the core networks.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device and from core networks, network data identifying the core networks supported by the network device and emergency service data identifying one or more of the core networks that support emergency services;
generating, by the network device and based on the network data and the emergency service data, system information that includes identifiers of the core networks and indicators of whether the core networks support emergency services; and
providing, by the network device, the system information to a user equipment to inform the user equipment about which of the core networks support emergency services.

2. The method of claim 1, further comprising:
receiving, from the user equipment, an emergency call directed to one of the core networks that supports emergency services, as selected by the user equipment based on the identifiers and the indicators included in the system information; and
directing the emergency call to the one of the core networks that supports emergency services.

3. The method of claim 1, further comprising:
receiving service data identifying service types provided by the core networks;
generating, based on the network data and the service data, a list identifying the core networks and priorities associated with service types provided by the core networks; and
providing the list to the user equipment to inform the user equipment about the priorities associated with the service types provided by the core networks.

4. The method of claim 3, further comprising:
receiving, from the user equipment, a request for a first service type, directed to one of the core networks that supports the first service type, as selected by the user equipment based on the list; and
directing the request for the first service type to the one of the core networks that supports the first service type,
wherein the one of the core networks is associated with a greatest priority for the first service type relative to the core networks other than the one of the core networks.

5. The method of claim 4, further comprising:
receiving, from the user equipment, a request for a second service type, directed to another one of the core networks that supports the second service type, as selected by the user equipment based on the list; and
directing the request for the second service type to the other one of the core networks that supports the second service type,
wherein the other one of the core networks is associated with a greatest priority for the second service type relative to the core networks other than the other one of the core networks.

6. The method of claim 1, wherein an emergency support bit of the system information includes the identifiers of the core networks and the indicators of whether the core networks support emergency services.

7. The method of claim 1, wherein the user equipment is connected to a private network supported by the network device.

8. A network device, comprising:
one or more processors configured to:
receive network data identifying core networks supported by the network device and emergency service data identifying one or more of the core networks that support emergency services;
generate, based on the network data and the emergency service data, system information that includes identifiers of the core networks and indicators of whether the core networks support emergency services;
provide the system information to a user equipment to inform the user equipment about which of the core networks support emergency services;
receive, from the user equipment, an emergency call directed to one of the core networks that supports emergency services, as selected by the user equipment based on the identifiers and the indicators included in the system information; and
direct the emergency call to the one of the core networks that supports emergency services.

9. The network device of claim 8, wherein an emergency support bit of the system information includes the identifiers of the core networks and the indicators of whether the core networks support emergency services.

10. The network device of claim 8, wherein the user equipment is connected to a private network supported by the network device.

11. The network device of claim 8, wherein the core networks are fifth-generation standalone core networks.

12. The network device of claim 8, wherein the core networks are fourth-generation evolved packet core networks.

13. The network device of claim 8, wherein the network device is a radio access network device.

14. The network device of claim 8, wherein a quantity of the core networks is greater than or equal to two and at least one of the core networks supports emergency services.

15. A non-transitory computer-readable medium storing a set of instructions, the set of instructions comprising:
one or more instructions that, when executed by one or more processors of a network device, cause the network device to:
receive network data identifying core networks supported by the network device and service data identifying service types provided by the core networks;
generate, based on the network data and the service data, a list identifying the core networks and priorities associated with service types provided by the core networks; and
provide the list to a user equipment to inform the user equipment about the priorities associated with the service types provided by the core networks.

16. The non-transitory computer-readable medium of claim 15, wherein the one or more instructions further cause the network device to:
receive, from the user equipment, a request for a first service type, directed to one of the core networks that supports the first service type, as selected by the user equipment based on the list; and
direct the request for the first service type to the one of the core networks that supports the first service type.

17. The non-transitory computer-readable medium of claim 16, wherein the one of the core networks is associated with a greatest priority for the first service type relative to the core networks other than the one of the core networks.

18. The non-transitory computer-readable medium of claim 16, wherein the one or more instructions further cause the network device to:
receive, from the user equipment, a request for a second service type, directed to another one of the core networks that supports the second service type, as selected by the user equipment based on the list; and
direct the request for the second service type to the other one of the core networks that supports the second service type.

19. The non-transitory computer-readable medium of claim 18, wherein the other one of the core networks is associated with a greatest priority for the second service type relative to the core networks other than the other one of the core networks.

20. The non-transitory computer-readable medium of claim 15, wherein the one or more instructions further cause the network device to:
receive emergency service data identifying one or more of the core networks that support emergency services;
generate, based on the network data and the emergency service data, system information that includes identifiers of the core networks and indicators of whether the core networks support emergency services;
provide the system information to the user equipment to inform the user equipment about which of the core networks support emergency services;
receive, from the user equipment, an emergency call directed to one of the core networks that supports emergency services, as selected by the user equipment based on the identifiers and the indicators included in the system information; and
direct the emergency call to the one of the core networks that supports emergency services.
